(19) United States
(12) Patent Application Publication
(10) Pub. No.: US 2007/0210929 A1
(43) Pub. Date: Sep. 13, 2007

(54) Mapping and Detection of Pipelines using Low Power Wireless Sensor Network

(76) Inventors: Ashok Sabata, Freehold, NJ (US); Bikash Sabata, Philadelphia, PA (US)

Correspondence Address: AGINOVA INC, 3 CHAMBRY COURT, FREEHOLD, NJ, 07728, US

(21) Appl. No.: 11/308,098

(22) Filed: Mar. 7, 2006

(51) Int. Cl. G08B 21/00; G08B 13/14; G01V 3/08

(52) U.S. Cl. 340/686.5; 340/572.1; 324/326

(57) ABSTRACT

A wireless sensor network will be used to detect the location of subsurface infrastructures such as a pipeline. The objective is to alert the infrastructure operator and the construction equipment operator of the threat of damage to the infrastructure. Currently the equipment operator has to depend on the color marks made by the locater sent by the One-Call center. The low cost wireless sensor network will alert the operator when the machine tool gets close to an existing utility. A combination of radio frequency signal, ultrasonic pulse, and acoustic signals is used to determine the infrastructure location. A sensor network is then used to map the infrastructure location with respect to the construction equipment operator and provide a reliable, accurate system to alert the operator of the potential danger.

### TECHNICAL FIELD

The current invention relates to the detection and mapping of subsurface infrastructures such as pipelines using a network of wireless sensors. In particular it relates to methods and systems that use a network of wireless mobile sensors to detect and warn in real time the existence of subsurface infrastructure.

### BACKGROUND OF INVENTION

The congressional Transportation Equity Act for the 21st Century, TEA 21, Title VII, Subtitle C, SEC. 87301, states that: “. . . unintentional damage to underground facilities during excavation is a significant cause of disruptions in telecommunications, water supply, electric power, and other vital public services, such as hospital and air traffic control operations, and is a leading cause of natural gas and hazardous liquid pipeline accidents.” According to the DOE (Department of Energy), third-party damage, which occurs when construction or excavation crews inadvertently strike underground utility lines, is by far the most costly and dangerous type of accident.

There are several parties involved in the excavation and trenching process. Active participants include owners of a new facility, designers, planners, contractors, utilities, locators, construction workers, and equipment operators. In most U.S states, a contractor is required by law to call a “One-Call Center” 48 or more hours before the dig is initiated. The one-call notification system is a communication network established to prevent excavation damage to the underground infrastructure, including natural gas and hazardous liquid pipelines, fiber optic cables, electrical, water and sewer systems. The one-call centers provide a central point of contact where excavators (e.g., utilities and their contractors, general contractors and subcontractors, and other entities that excavate the soil surface) call to provide advance notice of their plans to use equipment for excavating, tunneling, demolition, or otherwise disturbing subsurface areas. One-call systems accept calls from anyone needing to determine the location of underground facilities due to impending excavation. The centers allow participating members the opportunity to identify and mark their facilities in the vicinity of a proposed excavation. This identification and marking allows the excavation to proceed safely by minimizing the likelihood of contacting or damaging the vital subsurface infrastructure. This notification also affords the owners of underground facilities the opportunity to provide any necessary information about their facilities to excavators and to post a construction watch, if desired.

Despite the successful implementation of One-Call systems in most of the U.S., a wide variety if impacts still occur resulting in accidents ranging from a clogged residential sewer line to a gas explosion causing death and destruction. The list of impacted parties that incur cost comprises not only the contractor, utility and property owners, people in the vicinity of the accidents, but also the customers of a disrupted utility. Some of these groups include: a) private homes, b) governmental agencies, c) service companies, d) schools, e) hospitals, f) industrial firms, g) transportation systems like airports, taxi services, freight trains and trucking, h) retailers, and i) the utilities themselves. Overall, the direct and indirect costs of such accidents are staggering making the use of more sophisticated prevention approaches also economically prudent.

There have been several methods and techniques that have been proposed for detection of pipelines. One method proposes using techniques such as EMI (Electromagnetic Induction) or a GPR (Ground Penetrating Radar). Each of these methods individually has limitations, so integrated systems combining the 2 techniques have therefore been developed. Though the integrated combination has increased the accuracy of locating subsurface infrastructure, the cost and the size of the equipment make it difficult for every excavator to have one of these onsite. Because of these limitations, several alternative approaches are now under development.

The U.S. DOE in association with the Gas Technology Institute has developed Optical Time Domain Reflectometry and uses a fiber-optic sensor to aid in locating pipelines. Vibrations in the ground (created by construction equipment) cause compressions in the soil surrounding the pipeline and if the vibrations and soil compressions are sufficiently close to the pipeline, the fiber-optic cable will bend. Even a minute deformation in the cable will change its light transmission and reflection properties and send an early warning of a potentially hazardous encroachment. When an intrusion is detected, an alarm sounds, alerting the pipeline company of equipment encroaching on its pipeline. The system can also help pinpoint where along the pipeline the potential hazard is developing. Southwest Research Institute (SwRI) in San Antonio is developing a system that can detect infringements up to a distance of 3,634 feet when impressed with alternating cycle current. West Virginia University is developing a system that relies on acoustic signals that are carried by the gas inside the pipeline. Using the Pipeline Acoustic Monitoring Package (PAMP) installed on the pipeline the operator can then detect leaks and determine if anyone was hitting the pipeline from distances of about a tenth of a mile away.

Though there is considerable ongoing research activity in identifying a commercially viable method for locating pipelines and other subsurface infrastructure to prevent third party damage all the proposed solutions are either expensive and/or highly complex for widespread implementation and often times give false alarms.

Recently there has been technology progress in the area of wireless sensor platforms. Wireless sensor networks are increasingly being deployed within a physical environment of interest, and may measure aspects of the physical environment in great detail. Wireless sensor networks generally comprise of sensor nodes that are each operable to perform some measurement and communicate wirelessly. Sensor nodes are commonly equipped, with sensor(s), local storage, a processor, and wireless transceiver. Such sensor nodes typically have short-range wireless communication capability.

The sensor nodes are often inexpensive and have limited computation, memory, and communication capability and typically consume low power therefore are generally expected to be long-lived, untethered, and unattended for extended periods of time (years); the nodes typically communicate using short-range wireless communication. Sensor nodes may be deployed in a wireless sensor network as an ad-hoc deployment, wherein sensor nodes are dropped with no particular plan or pre-defined arrangement. After being deployed in this ad-hoc manner, the sensor nodes interact with each other to establish a communication network among them. In another deployment technique, sensor nodes are specifically placed in desired locations, wherein the sensors may be precisely positioned relative to one another. In a typical sensing deployment the sensor nodes have one or more sensors integrated with the platform. The sensors make periodic measurements and store or forward the measurement. Some nodes may never do any sensing and merely act as communication relay nodes for the other sensor nodes.

A significant operational constraint of sensor network is the energy. Local battery power drives the sensor electronics and the other communication related tasks. For long term deployments it is necessary to conserve the battery life by being very judicious about how much energy to spend for each task. Sensor nodes therefore have a sleep mode where the sensor nodes expend a minimum amount of energy by shutting down all functions including sensing and communicating. Only when the nodes wakeup do all the functions are enabled.

### BRIEF SUMMARY OF THE INVENTION

The present invention is directed to a system and method for mapping of subsurface infrastructure such as gas pipelines, water main, utility conduit, and fiber optic conduit with a low power wireless sensor network that is small, low cost, and rugged. In certain embodiments the system includes ultrasonic sensors, radio frequency sensors, acoustic sensors, and potentially a plurality of other active and passive sensing devices with wireless transceivers that together determine the exact location of the sensor when the sensor is placed in close proximity of the infrastructure.

In accordance with at least one embodiment, the system includes a wireless sensor network consisting of a plurality of nodes in a configuration that can locate the subsurface infrastructure in three dimensions and then transmit the location information to any device enabled to receive the information. The system further includes a device that is integrated with the sensing network that can alert in real time the pipeline operator and equipment operator of the threat of damage to the infrastructure as the machine tool approaches the infrastructure.

In at least one embodiment, the wireless network is configured using a Mesh Network consisting of a “mesh” of interconnected wireless transceivers. The network uses multi-hop routing that reduces power requirements.

Further, in accordance with at least one embodiment several of the nodes in the network are integrated with ultrasonic sensors and radio frequency sensors to triangulate and map the location of the pipeline or infrastructure. Additionally, GPS sensors are used as reference sensors.

In accordance with at least one embodiment Audio sensors and motion sensors can be used as early warning systems for detecting activity by means of methods such as the noise level. The approach of the noise provides additional cues to the computational procedure that does the accurate mapping in proximity of the infrastructure.

The present invention is a substantial advancement over prior systems and methods of locating subsurface infrastructure. Because the present invention utilizes low cost wireless devices called motes, the present invention also has the advantage that it does not require the extensive use of wires to transmit communication signals.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an example implementation of on embodiment of the invention;

FIG. 2 shows a more detailed example implementation of one embodiment of the present invention;

### DETAILED DESCRIPTION OF THE INVENTION

To more fully appreciate aspects of certain embodiments of the present invention, a brief discussion of techniques proposed in the prior art for collecting measurement data from wireless sensor networks is appropriate. Wireless sensor networks are usually implemented as a collection of small sensor devices (or “nodes”) communicating over low-power wireless links and powered by a battery. As mentioned above, the nodes of a wireless sensor network may be distributed in an ad-hoc manner. In such ad-hoc sensor networks, the communication between the sensor nodes is typically established via protocols that self-configure the ad-hoc network, as opposed to the designed communication topology of traditional networked measurement systems. Because these sensor nodes generally run on battery power and are expected to last for several years, severe constraints are typically placed on the amount of computation, and particularly on the amount and range of communication of the sensor nodes. As a result, various communication algorithms and operational parameters geared toward limiting battery drain have been proposed.

In the present invention describes the use wireless sensor network technology to prevent damage of sub-surface infrastructure such as pipelines. The damage caused by third-party such as construction crews is the single greatest threat to the pipeline integrity. For the exposition of the invention the term pipeline and sub-surface infrastructure is used interchangeably. Anyone with knowledge of the domain can easily extrapolate the methods of the invention to any sub-surface infrastructure.

The factors that cause the damage include—(1) The construction equipment operator unaware that there is a pipeline in the vicinity and (2) Knowing the exact location and depth of the pipeline. The latter can be a problem even for the pipeline operators. In urban (or other cluttered) environments, accurately mapping the pipeline (i.e. the latitude, the longitude and the depth) is challenging and expensive using current commercially available techniques.

The invention develops a methodology for a suitable warning system once the location of the pipeline is known. The warning system is to prevent 3rd party damage by informing both the pipeline operator and the equipment operator of danger of imminent damage. The invention develops a method and system to warn the presence of subsurface infrastructure such as gas pipelines, water main, utility conduit, and fiber optic conduit with a low power wireless sensor network that is small, low cost, and rugged. The system includes at least one sensor that could be one or more of ultrasonic sensors, radio frequency sensors, acoustic sensors, and potentially other active and passive sensing devices with wireless transceivers that together determine the exact location of the sensor when the sensor is placed in close proximity of the infrastructure.

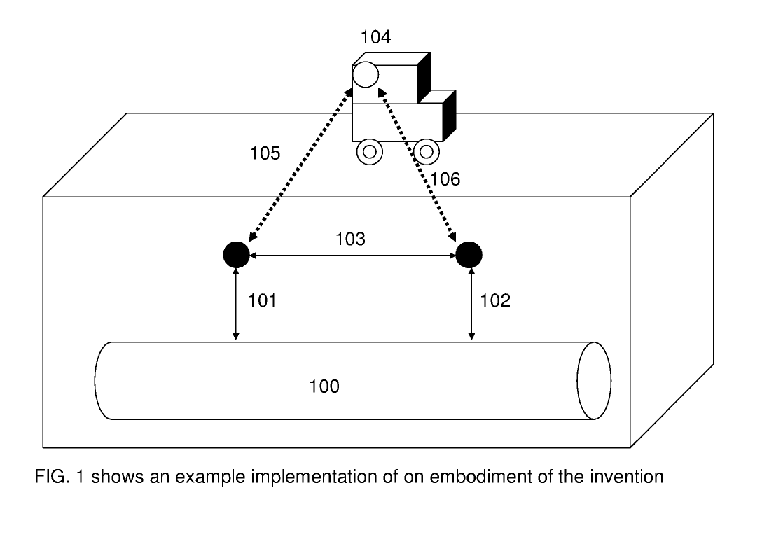

In the simplest form FIG. 1 is a conceptual schematic of the proposed system. The system includes a network of nodes in a configuration that can transmit the three dimensions of the location information. The nodes can be placed in an ad hoc manner with the location of the pipe stored in its memory that upon request will transmit the co-ordinates of the pipeline over the area of interest. Alternatively, the nodes are placed at known distances to the pipeline (101, 102). The distance between the sensor nodes (103) is known accurately at the time of the placement of the nodes. The sensor nodes are placed long before any construction equipment comes for excavation activity near the pipeline (100). The system further includes a device (104) that can alert the pipeline operator and equipment operator of the threat of damage to the infrastructure as the machine tool approaches the infrastructure.

The wireless network is configured using a Mesh Network consisting of a “mesh” of interconnected wireless transceivers. The network uses multi-hop routing that reduces power requirements. Several of the nodes in the network are integrated with ultrasonic sensors and radio frequency sensors to provide the device on the construction equipment data that is used to calculate its distance from the location of the pipeline (105, 106). Location markers with sensors act as reference points to increase accuracy (for example at 104). The use of low cost and low power wireless devices called motes gives a significant advantage over existing systems and ongoing development projects.

The invention consists of a method to compute the relative separation of the construction equipment and the subsurface infrastructure using a mesh of networked wireless sensor devices that either know the location of the pipeline and placed in the area or are placed adjacent to the infrastructure prior to the beginning of the construction activity; the construction equipment also has wireless devices that become part of the network when the equipment comes within close proximity to the infrastructure mesh; Audio sensors and motion sensors can be used as early warning systems for detecting activity such as the noise level and the approach of the noise provides additional cues to the computational procedure that does the accurate mapping in proximity of the infrastructure. To improve accuracy the different sensor cues are fused within a computational framework based on Bayesian Networks.

In the simplest form of the invention at least one wireless sensor node is placed in the area of interest. To cover a larger area several wireless nodes can be placed to create a mesh network. All the nodes have the location information of the sensor node and that of the pipeline in its memory. When the device in the construction equipment is in within the range of the wireless sensor network it communicates a wake-up signal to the nodes within range to cause it to increase its power to a level suitable for communication to transmit the location information. Using the sensor node and the computational procedure the device provides the construction operator its position with respect to the pipeline.

In another embodiment of the invention an array of sensors as placed adjacent to the pipeline and the system to measure distance from the pipeline using sensors such as ultrasonic and radio frequency sensors where using their relative difference in the time of arrival of the ultrasonic and radio frequency pulses the distance between the sender of the pulse and the receiver of the pulse is computed whereby placing the source of the pulses at the construction equipment, the sensor nodes embedded with the infrastructure then computes the relative distance and orientation of the equipment with respect to the infrastructure then provides the location to the construction equipment operator on a device that is continuously updated with distance of equipment to the infrastructure and providing audible and/or visual warning when approaching very close to the infrastructure. The source of the pulse may also be at the motes embedded with the infrastructure. However, it may be more efficient in terms of power consumption to make the source of the pulses be at the device on the construction equipment.

Since the path between the source of the pulse signal and the receiver passes through air and the subsurface, the computation of the distance and the orientation is not straight forward [Reference 4]. Multiple paths between different locations of the source and the same receiver are needed to disambiguate the subsurface from the air. A principle similar to the tomographic computations is used in the invention to calculate the location of the receiving motes with respect to the sending motes accurately. A reference sensor (with its location in memory) can provide the absolute location of the source of the pulse signals. GPS sensor on the construction equipment could also be such a reference point. Although the GPS location has errors in the order of 3 ft, the relative distances measured between two surface points within the same neighborhood is fairly accurate. The relative position of the receiver with respect to the sender is computed while taking into account the error of the different estimates. As multiple measurements are made from different points (as the construction equipment moves about), the accuracy of the measurements improve and reach the resolution sufficient to avoid an incident.

The relative positions of the motes embedded within the infrastructure are accurately mapped at the time of installing the sensor motes. The map also includes the depth of the motes from the surface. This information is available at the motes for the computations required to map the location of the infrastructure relative to the construction equipment. The distributed measurements across the sensor mote mesh are used collaboratively to compute the individual mote position with respect to the construction equipment.

Additional sensors being developed to detect sub-surface pipelines can be integrated with the computational procedure to improve the accuracy of the mapping and detection system. The different sensor cues are fused within a computational framework based on Bayesian Networks. Any of other data and information fusion approaches may also be used for the fusion of different types of sensor readings.

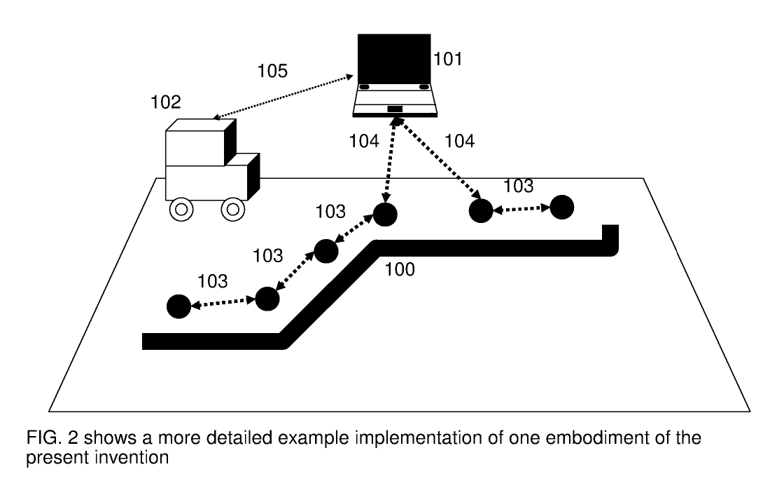

The sensor nodes in the network in general may have very limited resources for computations. This constraint is not of much importance as our architecture transfers the bulk of the computations to an external node that interfaces with the nodes in the sensor network. This special node will be an off-the-shelf portable computer with sufficient compute and power resources. The central processor will reside on the construction equipment or at the construction site in the vicinity of the construction equipment. FIG. 2 illustrates the concept. The sensor nodes communicate to the central analysis engine (101) periodically with the local measurements. The communications uses the Mesh Network of the sensor motes. Since the motes operate asynchronously, each measurement is tagged with the local time stamp and a sequence number for the central analysis engine to correlate measurements across the sensor network.

The measurements at each mote are stored within their own local repository and when communications channel become available a batch of measurements is transmitted to the Analysis engine. The analysis engine creates a combined measurement repository indexed by time, mote id, location, and type. The measurements are then used within a Bayesian analysis framework to compute the likelihood of the construction equipment causing mechanical damage to the pipeline.

The Bayesian Statistical technique that estimates the probability of mechanical damage uses the knowledge that measurements from nearby nodes are correlated but the nodes' biases are independent. The variables measured at the different motes (e.g., the time difference of arrival) globally form a Markov graph. Further, the snap-shot of the variables at any time instant forms a Markov graph which is related to the Markov graph at the next time instant. The emergent dynamic temporal Markov Graph can be solved to compute the posterior estimate of the true distance of the construction equipment from the pipeline. Note that at the different times only a subset of the nodes reports their measurements, therefore the measurement repository will have missing measurements. Further, measurements sometimes can come at a later time. The Bayesian/Markov Network modeling of the domain addresses the problems related to missing measurements and delayed measurements very elegantly. The computational procedures are robust to such errors. Further, sensitivity analysis of the computed results will indicate if the absence of the measurements is critical to make a decision regarding potential dangers. The computational procedure updates the estimates as the measurements are filled into the repositories. The influence of the past measurements on the current inference decays in time and therefore very old measurements will be ignored by the analysis engine. Numerous exact and approximate computational procedures exist that solve Markov Graphs. In this application we do not anticipate that the computations will be a bottleneck. Since the time lag for making decisions is in the order of minutes—not milliseconds, the computational procedures will converge before time becomes a critical factor.

When the construction equipment enters the proximity of the pipeline, the sensor network awakens and performs an initialization procedure where the central analysis engine is notified about the sensor nodes, their locations and the capabilities (sensor types and accuracy). The registration and initialization procedure is simple and robust to different types of errors. The localization and calibration procedures will be performed at the initialization phase and periodically during the construction operations.

The data collected during the encounter of a construction team within a location on the pipeline will be put back into a long term archive that will be used to learn models of measurement biases and correlations within different contexts. For example, if the construction was happening during rain, the environmental influence on the measurements will be significantly different from those on a dry day. If the prior models for the location are stored then the next time a different construction team comes to work in the same location, it can preload the models for more accurate estimation and analysis. Depending on the size of the models, we may be able to save the models at the location itself within the sensor network. Alternatively, the construction crew obtains the models along with the permission to dig at the location (they will probably also lease the central analysis engine and the sensor to be mounted on the construction equipment before arriving at the location).

What is claimed is:

1. A method for detecting underground infrastructures such as gas pipelines to prevent third party damage, method computing the relative separation of the construction equipment and the subsurface infrastructure using at least one wireless sensor node that either has the pipeline location information or are placed adjacent to the infrastructure prior to the beginning of the construction activity; the construction equipment also has wireless devices that become part of the network when the equipment comes within close proximity to the infrastructure mesh; The different sensor cues are fused within a computational framework to determine the location of the underground structure with respect to the construction equipment.

2. The method of claim 1 further comprising: said sensor node can form a mesh network with other sensor nodes or wireless nodes.

3. The method of claim 1 further comprising: wireless device on the construction equipment that when within range or the wireless sensor network or within range of at least one node in the wireless network, said device communicates a wake-up signal to said at least one node to cause it to increase its power to level suitable for communication so that the device becomes part of the network when the equipment comes within close proximity to the infrastructure mesh.

4. A system to prevent third party damage, system comprising of a wireless sensor network that consist of an array of sensors nodes embedded with the infrastructure that computes the relative distance and orientation of the equipment with respect to the infrastructure and using a reference marker for accuracy of distance provides the location to the construction equipment operator on a device that is continuously updated with distance of equipment to the infrastructure and providing audible and/or visual warning when approaching very close to the infrastructure.

5. The method of claim 4 further comprising sensors that use the relative difference in the time of arrival of the signal between the sender of the pulse and the receiver of the pulse whereby placing the source of the pulses at the construction equipment to calculate the distance.

6. The method of claim 4 further comprising of pulsed communications between the ultrasonic and radio frequency sources and detectors such that the relative difference in the time of arrival of the ultrasonic and radio frequency pulses is used to compute the distance between the sender of the pulse and the receiver of the pulse.

7. The method of claim 4 wherein the reference marker on the ground or on the construction equipment has a location sensor such as a GPS device or a low power beacon that transmits location information and is integrated with one or more wireless sensor devices.

8. A method to compute the relative distance between the construction equipment and the sensor nodes comprising of computational procedure that computes the relative separation of the construction equipment and the subsurface infrastructure with increasing accuracy by fusing the plurality of distance computations.

9. The method of claim 8 wherein the computation performs the evidence fusion within a computational framework based on Probabilistic Networks which includes but is not restricted to Bayesian Networks and Markov Networks.

10. The method of claim 4 wherein the audio and visual warning system includes a device that graphically displays on a geographical map the location of the construction equipment and the pipeline and the audio warning is triggered by the distance computation in claim 8.
